(19) United States
(12) Patent Application Publication
(10) Pub. No.: US 2025/0321962 A1
(43) Pub. Date: Oct. 16, 2025

(54) ANALYTIC PLATFORM TUNING USING LARGE LANGUAGE MODELS

(71) Applicant: Teradata US, Inc., San Diego, CA (US)

(72) Inventor: Louis M. Burger, Escondido, CA (US)

(21) Appl. No.: 18/822,171

(22) Filed: Aug. 31, 2024

Related U.S. Application Data
(60) Provisional application No. 63/633,357, filed on Apr. 12, 2024.

(51) Int. Cl. G06F 16/2453; G06F 16/242

(52) U.S. Cl. CPC G06F 16/24542; G06F 16/243; G06F 16/2445

(57) ABSTRACT

A system may include a plurality of processing nodes in communication with a storage device configured to store a plurality of data. The processing nodes may receive a query on at least a portion of the data and may generate a query plan in natural language format. The processing nodes may generate a large language model (“LLM”) input based on the natural language format of the query plan and may execute an LLM on the LLM input. The processing nodes may generate, in response to execution of the LLM, a plurality of recommended actions to perform to improve the query plan. The processing nodes may receive input to execute at least one of the plurality of recommended actions and may alter the query plan in accordance with the at least one of the plurality of recommended actions. A method and computer-readable medium are also disclosed.

### CLAIM OF PRIORITY

This application claims the benefit of priority under 35 U.S.C. § 119(e) of U.S. Provisional Patent Application Ser. No. 63/633,357 filed on Apr. 12, 2024, which is hereby incorporated by reference herein in its entirety.

### BACKGROUND

Automated database tuning involving the recommendation of indexes, materialized views, statistics collections, and configuration settings or “knobs” has been a focus of research and industry offerings for decades with much of the recent work applying machine learning methods. Unfortunately, the success of such automated tuning has been spotty. As such, database administrators and expert SQL programmers continue to invest significant time and effort in the manual tuning of queries which often involves analyzing natural language text describing query plans.

AI-driven solutions have become popular and provide a vehicle for automated database tasks that no longer require manual intervention. However, without specific knowledge for specific databases, this AI-drive solutions may not provide optimal results. In order to take advantage of these types of solutions, training data must be curated to as to properly train the AI-solution.

Because traditional LLMs do not provide accurate database analyses, it would be desirable to train an LLM with specific data in order to properly automate database functionality without manual intervention.

### SUMMARY

According to one aspect of the disclosure, a system may include a storage device configured to store a plurality of data. The system may further include a plurality of processing nodes in communication with the storage device. The processing nodes may receive a query on at least a portion of the data. The processing nodes may further generate a query plan in natural language format. The processing nodes may further generate a large language model (“LLM”) input based on the natural language format of the query plan. The processing nodes may further execute an LLM on the LLM input. The processing nodes may further generate, in response to execution of the LLM, a plurality of recommended actions to perform to improve the query plan. The processing nodes may further receive input to execute at least one of the plurality of recommended actions. The processing nodes may further alter the query plan in accordance with the at least one of the plurality of recommended actions.

According to another aspect of the disclosure, a method may include, receiving, with a processor, a query on at least a portion of data stored in a storage device. The storage device is in communication with the processor. The method may further include generating, with the processor, a query plan in natural language format. The method may further include generating, with the processor, a large language model (“LLM”) input based on the natural language format of the query plan. The method may further include executing, with the processor, an LLM on the LLM input. The method may further include generating, with the processor, in response to execution of the LLM, a plurality of recommended actions to perform to improve the query plan. The method may further include receiving, with the processor, input to execute at least one of the plurality of recommended actions. The method may further include altering, with the processor, the query plan in accordance with the at least one of the plurality of recommended actions.

According to another aspect of the disclosure, a non-transitory computer-readable medium may be encoded with a plurality of instructions executable by a processor. The plurality of instructions may include instructions to receive a query on at least a portion of data stored in a storage device. The plurality of instructions may further include instructions to generate a query plan in natural language format. The plurality of instructions may further include instructions to generate a large language model (“LLM”) input based on the natural language format of the query plan. The plurality of instructions may further include instructions to execute an LLM on the LLM input. The plurality of instructions may further include instructions to generate, in response to execution of the LLM, a plurality of recommended actions to perform to improve the query plan. The plurality of instructions may further include instructions to receive input to execute at least one of the plurality of recommended actions. The plurality of instructions may further include instructions to execute an LLM on the LLM input. The plurality of instructions may further include instructions to alter the query plan in accordance with the at least one of the plurality of recommended actions.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is an example of output of an EXPLAIN statement.

FIG. 6 is a block diagram of example training of a custom large language model.

FIG. 7 is an example of a prompt template used for a single query.

FIG. 8 is an example query editor interface.

FIG. 9 is an example of recommended query tuning actions provided by a custom large language model.

FIG. 10 is an example of a prompt template used for workloads.

FIG. 11 is an example of a report for workload tuning.

FIG. 12 is an operational flow diagram of an example training of a custom large language model

FIG. 13 is an operational flow diagram of example operation of a query editor interface.

### DETAILED DESCRIPTION OF THE FIGURES

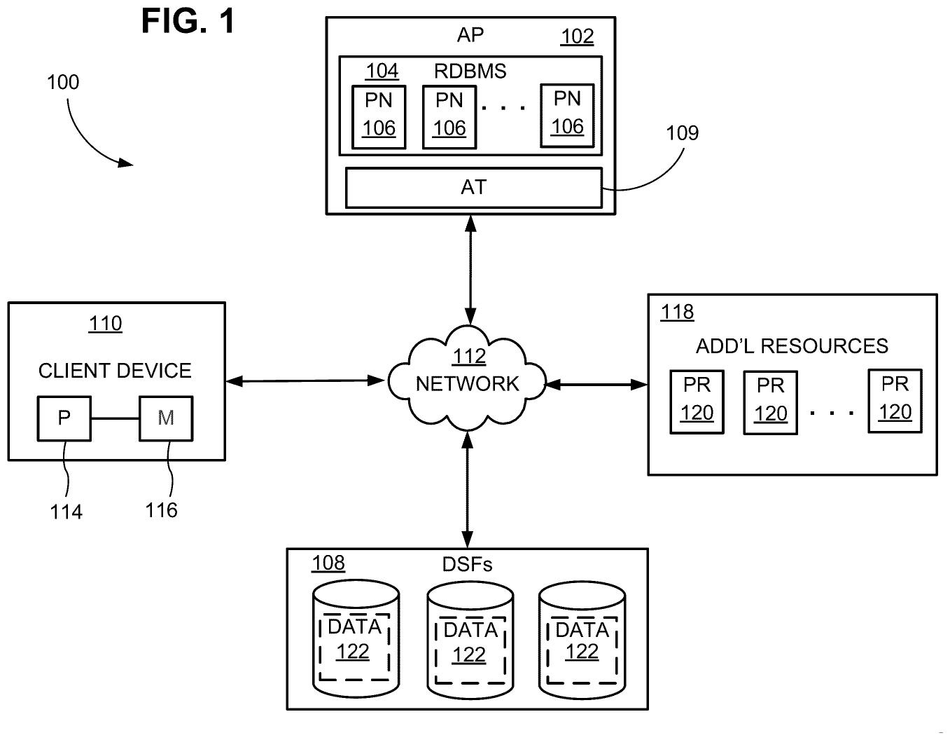

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in carrying out advanced analytics. The analytic platform 102 may include a relational database management system (“RDBMS”) 104. In one example, the RDBMS 104 may implement a parallel-processing environment to carry out database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

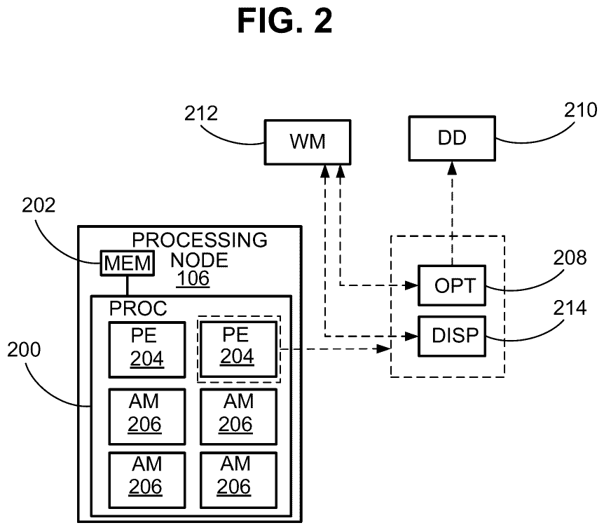

FIG. 2 is an example of a processing node 106, which may include one or more physical processors 200 and memory(ies) 202. Memory(ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, that includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

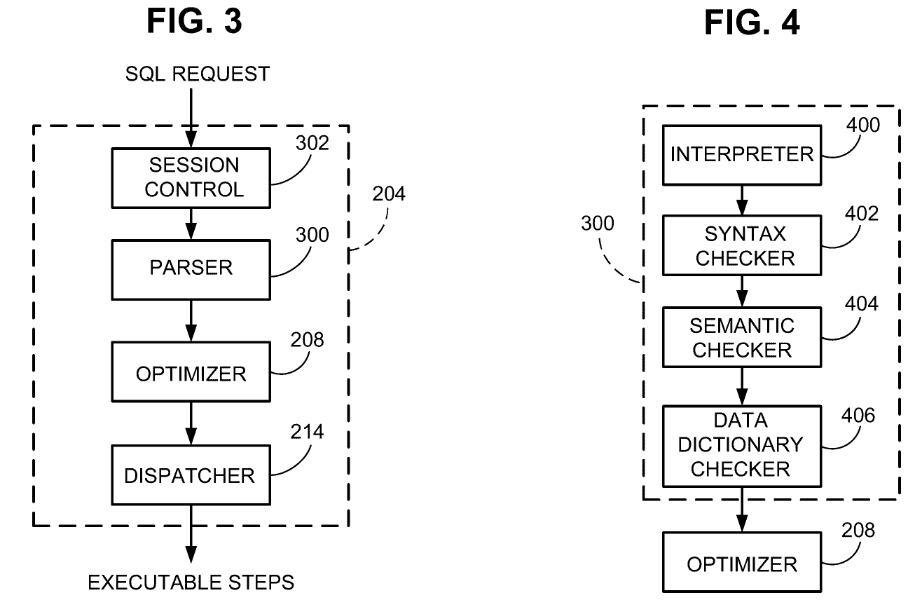

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming

request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

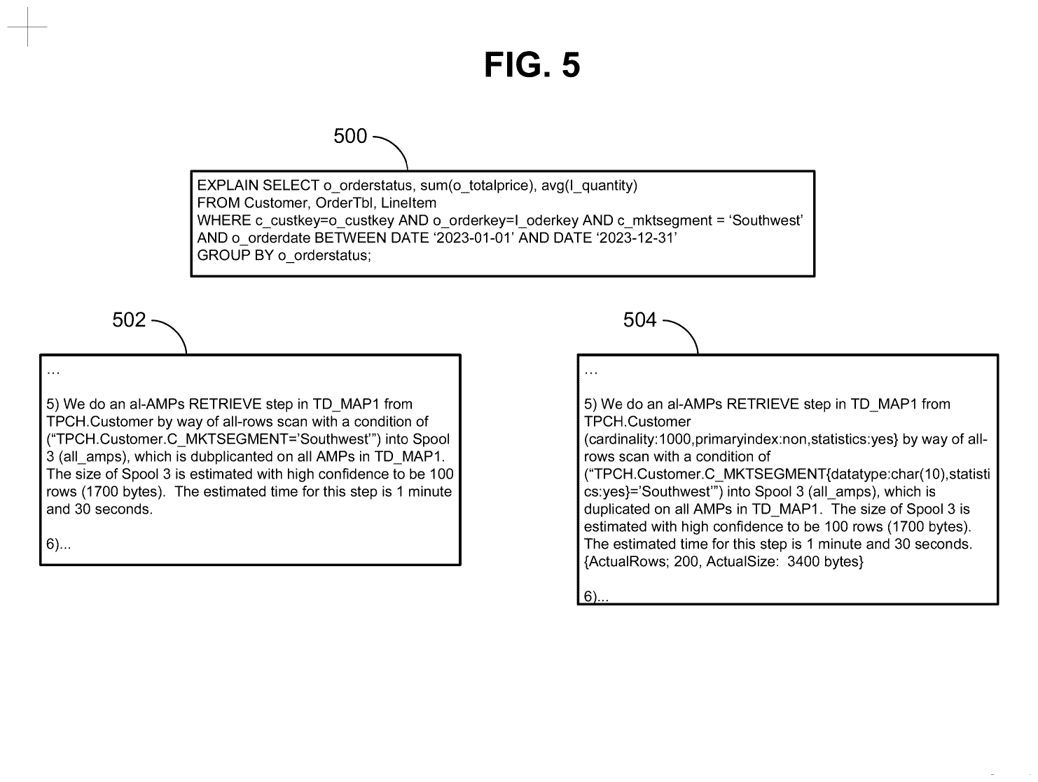

AI-driven techniques may be implemented in the analytic platform 102 allowing more advanced analytic performance to take place. In one example, some databases may allow query steps to be provided in natural language based on SQL or other database language syntax, which may, in turn, be used to guide AI capabilities. One such feature used to generate natural language based on query syntax is EXPLAIN. In one example, an EXPLAIN statement may be used to leverage the capabilities of a finely-tuned large language model (“LLM”). An EXPLAIN command may return the execution plan of a parsing engine module 204 in natural language form. When a query is preceded with EXPLAIN command, the execution plan of the parsing engine module 204 is returned to a user instead of access module 206 for execution. FIG. 5 is an example of an EXPLAIN statements with varied degrees of detail. In one example, an EXPLAIN statement 500 may be received by the RDBMS 104. Typically, an EXPLAIN statement will provide a number of query steps. EXPLAIN output 502 is an excerpt of a standard EXPLAIN statement with details allowing adjustments/recommendations to be made to a query plan. However, the EXPLAIN statement can be altered to provide an increased amount of details typically not delivered to a user. However, the EXPLAIN statement with additional details is more useful for an AI-driven LLM that may use the additional details to make finer-grained observations and adjustments/recommendations. In FIG. 5, EXPLAIN output 504 is a more detailed version of the EXPLAIN output 502. The details may vary per use case, but some examples of additional details may include statistical information about data being queried on. These additional details may be leveraged though an LLM to enhance the accuracy/efficiency in generating query plans.

In one example, AI-drive LLMs may be used to tune database queries handled by the optimizer module 208. Although many pre-trained models are mostly static (i.e., GPT-4 used by the popular ChatGPT), LLMs may be further trained on domain-specific data. This is especially critical for specialized tasks such as database query tuning where data found on the internet is insufficient and potentially inaccurate. Because retraining the model on an expanded full data set is computationally prohibitive, performing “fine-tuning” on a smaller dataset that has been validated for its accuracy and often labeled to support supervised learning is more efficient. Such “supervised fine tuning” results in the model's weights or parameters being adjusted according to the task specific learning.

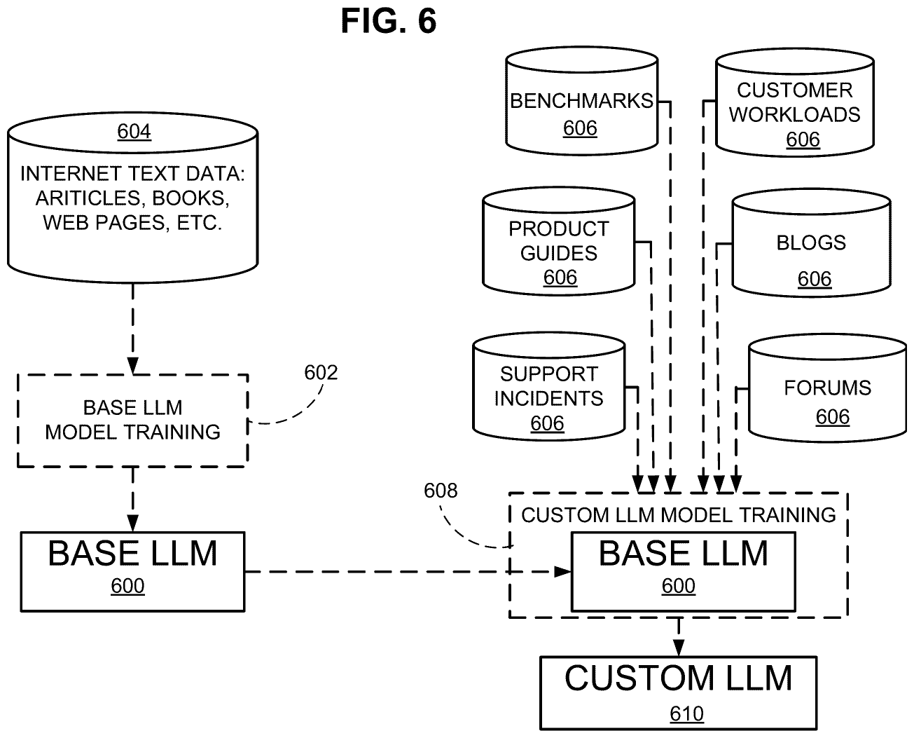

FIG. 6 is an example of training an LLM to provide specific database query tuning. A base LLM 600 may be generated through model training 602 using general internet training data 604. Various methods may be used in model training 602 to train an LLM, such as through self-supervised learning process, supervised learning process, and/or reinforcement learning process, which allows an LLM to acquire its abilities by learning statistical relationships from vast amounts of text during the learning processes. The general internet training data 604 may contain various resources such as articles, books, web pages, or any other informational resource that may be found on the internet. As previously mentioned, while general internet information is sufficient enough for some LLMs, this information is too limited and/or inaccurate to generate an LLM for domain-specific tasks. Once the base LLM 600 is created, domain-specific training data 606 may be used to generate a custom LLM 608 via custom LLM model training 610.

The custom LLM 610 allows fine-tuning for specific database engines and the optimizer module 208 along with the features and tuning options available within a particular software release. The domain-specific training data 606 may be “validated” and “labeled” and consist primarily of expert-tuned query plans (in EXPLAIN text format) collected from logged telemetry captured from in-house performance benchmarks, as well as production workloads of selected customers. Many cloud database vendors routinely ask customers to participate in telemetry collection programs intended to improve their product with customer usage data. Such query plans are analogous to well written essays that have undergone proper editing and proofreading. To facilitate this collection, a database engine may capture EXPLAIN outputs as part of the query logging subsystem. In addition to EXPLAIN telemetry, validated domain-specific training data 606 may also include vendor's documented best practices for tuning (e.g., product descriptions), customer support incidents with solutions related to query tuning, and vendor sanctioned online blogs and forums where experts offer tuning advice for user submitted questions. The specific domain-specific training data 606 shown in FIG. 6 are illustrative and non-exhaustive as other resources may be used instead or in addition to those shown in FIG. 6.

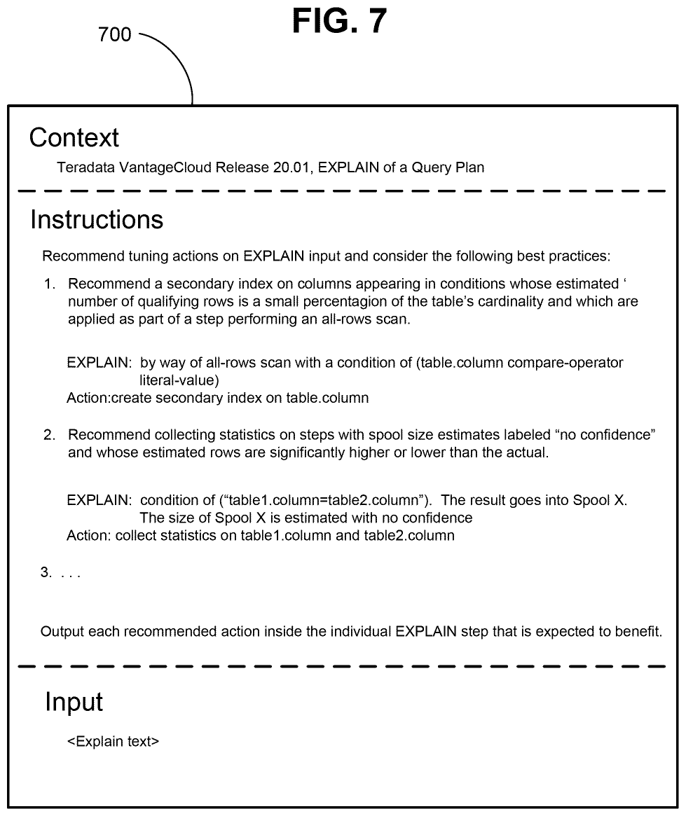

To facilitate use of the custom LLM 610, prompt templates may be used to provide specific instructions and additional context as part of the question (prompt) submitted to an LLM's user interface (i.e., chatbot or public API) with the intention of producing the most meaningful response for the task at hand including both its content and format. Supplementing the instructions with a handful of demonstration input-output pairs may be highly effective and is referred to as “few-shot learning”. FIG. 7 is an example of a prompt template 700, that contains a set of instructions each representing a tuning best practice for a given database engine where each instruction is supplemented with a few-shot example. While some best practices for query tuning are common to most SQL database engines, key differences in their query processing methods and tuning options are sufficient to warrant designing a separate prompt template for each engine and major software release. The prompt template 700 may include one or more short descriptions of a tuning best practice and an example demonstrating how the perform the practice, as shown in the example of FIG. 7. The process for generating the content of the template may involve summarizing existing material taken from published user manuals of a database engine, training material, and sanctioned question and answer websites.

Users experimenting with new queries will often examine an associated EXPLAIN statement prior to its initial submission to ensure the estimated processing time and resource consumption of the optimizer module 208 is not excessive. In addition, users will often analyze EXPLAIN statements of already executed (historical) queries, particularly if the resulting performance was poor. Both use cases can operate as part of existing interactive tools that submit queries and displays their results along with a new option requesting the EXPLAIN output of the optimizer module 208 be returned in lieu of, or in addition to, the data results. If the user requests system generated tuning recommendations, the EXPLAIN text is embedded within the previously described prompt template and passed to the LLM's designated public API. In the case of historical queries, this workflow is modified with the user exploring historical query logs by filtering on various attributes (username, time period, etc.) and then fetching the logged EXPLAIN text for their chosen query.

Depending on the requested output format specified in the prompt template, tuning recommendations generated by the LLM can be added to the original EXPLAIN as highlighted comments embedded close to the portion of plan text that is expected to benefit or alternatively as standalone content. While the first alternative delivers a better user experience, smaller output formats can reduce financial costs for those LLMs whose pricing formula is based on response/completion sizes.

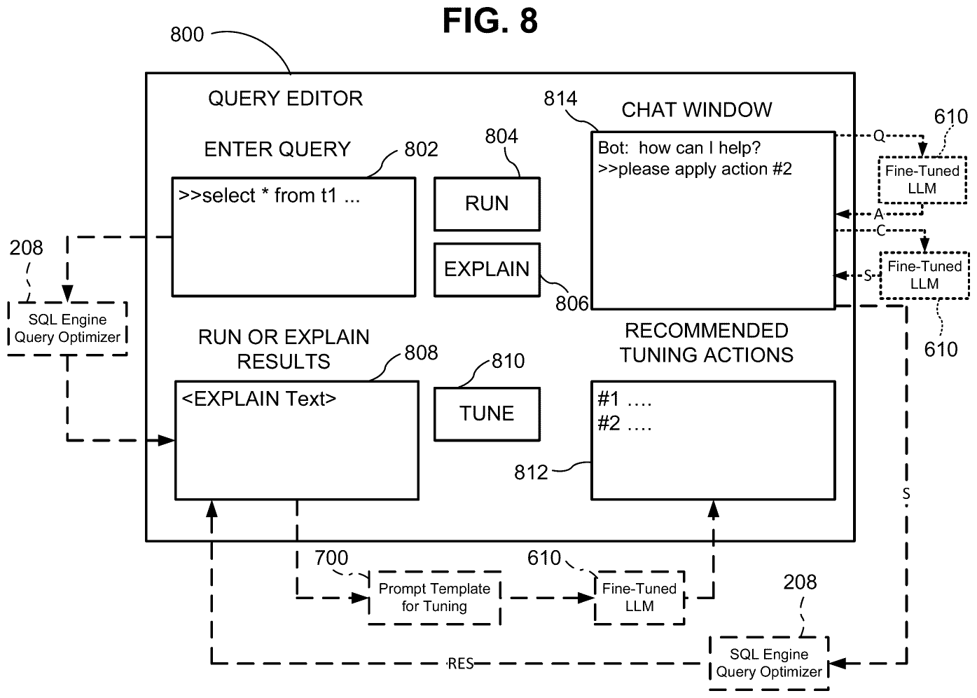

FIG. 8 is an example of a query editor (“QE”) interface 800 that implements AI-driven LLM techniques discussed herein, which may be executed on the client device 110 or other interface in communication with the analytic platform. In one example, the query editor interface 800 may receive a query through the “ENTER QUERY” field 802. The QE interface 800 includes “RUN” and “EXPLAIN” virtual buttons 804 and 806, respectively. Selection of the “RUN” virtual button 804 will execute the query entered into the field 802, which will produce result rows representing answers to the submitted query in the “RUN OR EXPLAIN RESULTS” field 808. Selection of the “EXPLAIN” virtual button 806 will provide the EXPLAIN text in the field 808. As illustrated in FIG. 8, a query entered in the field 802 will be processed by the optimizer module 208 in executing the query or generating the EXPLAIN results in field 808.

Once the EXPLAIN results are provided in field 808 or if the query is executed, the query editor interface 800 offers the option to tune the query via “TUNE” virtual button 810. In one example, selection of the TUNE virtual button 810 may generate a prompt template 700 allowing recommended tuning actions to be generated, which is provided to the custom LLM 610. The custom LLM may then determine recommended tuning actions to be provided in the “RECOMMENDED TUNING ACTIONS” field 812. A “CHAT WINDOW” field 814 may allow input to provide a command, such as applying the recommended actions in field 812 or asking additional questions (in natural language) about the LLM's generated tuning recommendations. In FIG. 8, a question (“Q”) provided via the field 814 may be passed to the fine-tuned LLM 610, which may provide an answer (“A”) back to the field 814. In another example shown in FIG. 8, a natural-language description of a database command (“C”) may be provided via the field 814, which may be passed to the fined-tuned LLM 610. The fine-tuned LLM 610 may provide the SQL syntax (“S”) to carry out the command C. The field 814 may receive input to execute the SQL syntax S, which causes the SQL syntax S to be passed to the optimizer module 208 for execution. The results (“RES”) of the executed SQL syntax S may be presented in the field 808. The field 814 may receive a variety of other input allowing input to leverage the fine-tuned LLM 610 to allow an expansive utilization of database functions. Many LLMs support a conversational context that spans multiple prompts. LLMs have already proven themselves capable of translating natural language requests into SQL and although this is typically done in conjunction with SQL's Data Manipulation Language (DML) statements, it may be extended to Data Definition Language (DDL) statements.

Recommending tuning actions for query plans requires an understanding of the optimizer module's 208 currently chosen execution steps including the access paths and join strategies performed at each step along with identifiers of the objects and intermediate results (e.g., spool files) being referenced as a source or target. The EXPLAIN feature offered by various database vendors may include this basic information and some include additional information such as optimizer confidence levels, which in turn is often an indicator of missing statistics. Accurate tuning also requires an understanding of object schemas including table sizes, the primary index or physical ordering attribute, defined secondary indexes, column data types, and already collected statistics.

Database engines store object definitions in their data dictionary, such as data dictionary 210, where they are accessible to the optimizer module 208 via internal APIs and to end users, typically through system supplied SQL views. As such, database vendors anticipate that users analyzing terse EXPLAIN text can separately retrieve supplemental information via standard query editor and administrative tools.

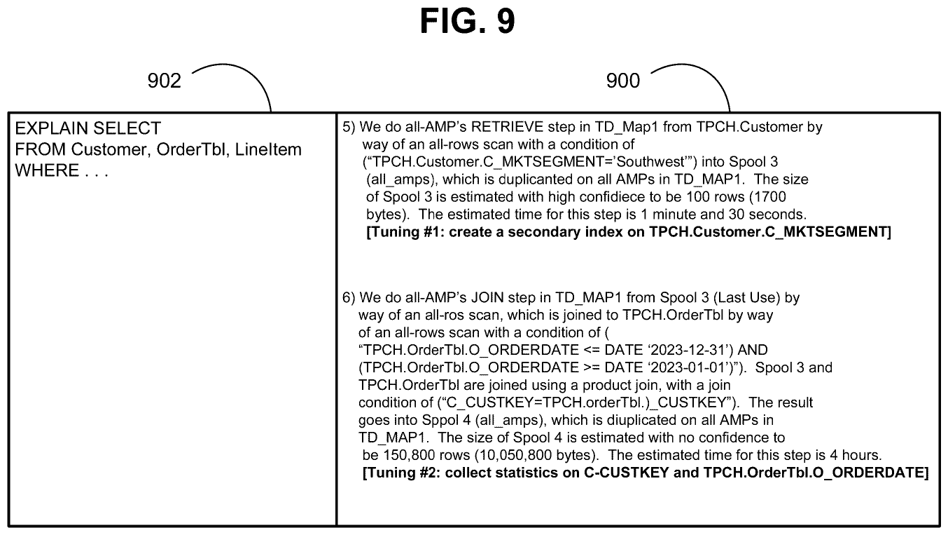

In addition to object definitions, EXPLAIN for historical logged queries is annotated with recorded actuals to facilitate identifying optimizer module 208 inaccuracies. Poor estimates often result in sub-optimal plans but can often be corrected with the collection of additional statistics that summarize the demographics of the accessed data. For optimizer modules that support dynamic plan selection, portions of the plan including step types and their order can change during execution and the corresponding changes must be reflected in the logged EXPLAIN text. FIG. 9 is an example of recommendations 900 provided by the custom LLM 610, such as that might be provided in field 812.

While tuning specific queries provides advantageous results, increased impact on query execution may be utilized through tuning workloads. The resource usage required for many tuning actions including materialized views is quite high and such costs must be amortized over multiple benefitting queries to yield a net improvement in overall system performance or consumption. As such, users responsible for tuning applications will typically analyze the EXPLAINs for all queries in the corresponding SQL workload (or more commonly a representative subset) and focus on making tuning actions that benefit multiple queries. FIG. 9 provides a sample of LLM recommendations 900 for an individual query 902. Neither the entirety of query 902 nor the entirety of the EXPLAIN output are shown in FIG. 9, but rather, FIG. 9 is an illustrative example of the capabilities of the LLM recommendations.

The previously described workflow for capturing EXPLAIN text for a single query and submitting it to an LLM API as part of a prompt template can be extended for a workload by simply concatenating the individual EXPLAINs and using a delimiter analogous to a chapter break within a natural language book. In turn, the instructions and few-shot examples specified within the prompt template are enhanced to assist the LLM in understanding the concept of a workload and to favor recommendations that benefit multiple EXPLAINs.

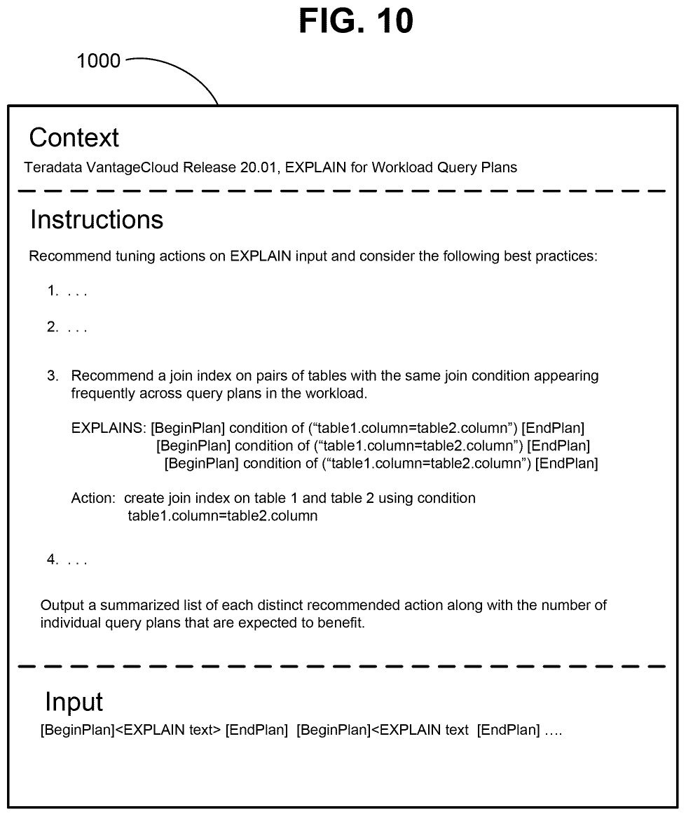

The user experience for tuning workloads must be altered from that previously described for tuning individual queries. Users first define a workload using common classification criteria (e.g., the name of the submitting user or application) and whose values are included in the logged telemetry for all queries. Database systems that offer advanced workload management systems will often have named workloads already defined using similar classification criteria. After establishing the criteria for defining a workload, qualifying queries and their associated EXPLAINs may be fetched from historical query logs (for a user specified time period) and submitted to the LLM as part of the prompt template designed for workloads. FIG. 10 is an example of a prompt template 1000 used for workloads.

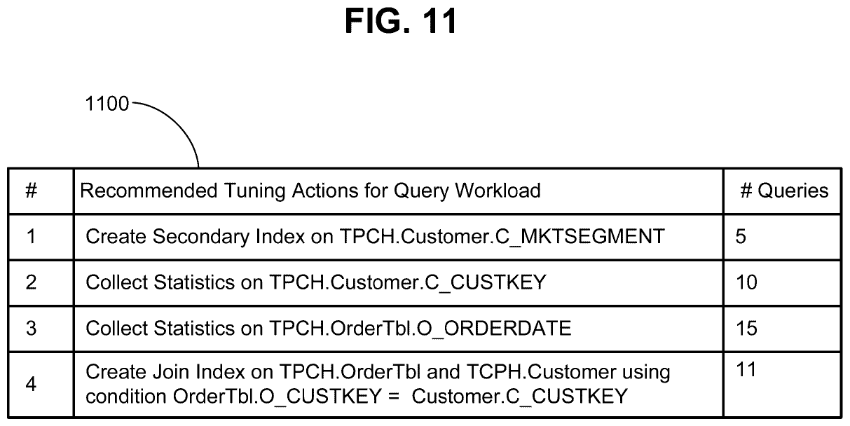

The LLM's output format for making recommendations on broader workloads may be in the form of a summary report consisting of the usual quasi-NL descriptions for each distinct recommendation along with the number of workload queries expected to benefit, such as report 1100 shown in FIG. 11. If the query logging subsystem assigns a unique identifier for individual logged query instances and their associated EXPLAIN statements, they can be included within each recommendation representing specific queries whose performance is expected to benefit. FIG. 11 is an example of a tuning report 1100 generated for a workload.

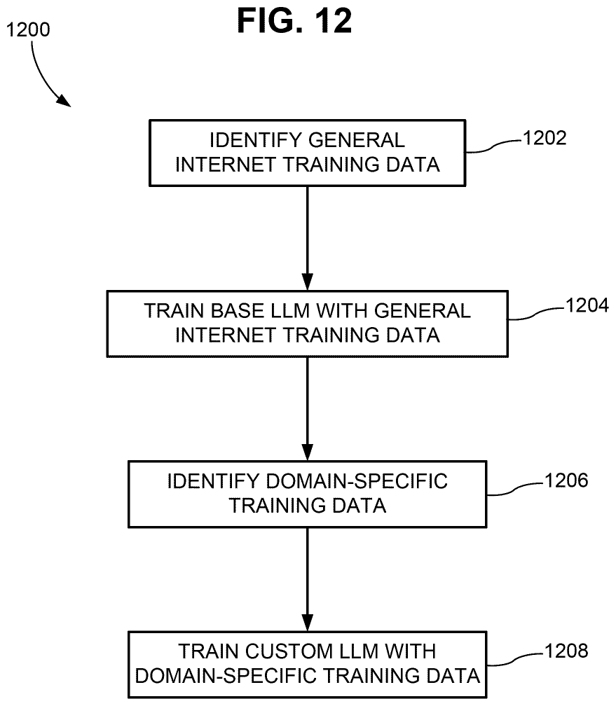

FIG. 12 is an operational flow diagram 1200 of training of the custom LLM 610. In one example, general internet training data 604 may be identified (1202). The base LLM 600 may be trained with the base LLM model training using the general internet training data 604 (1204). Once the base LLM 600 is created, the domain-specific training data 606 may be identified (1206). The domain-specific data 606 may be used to generate the custom LLM 610 via the custom LLM model training (1208).

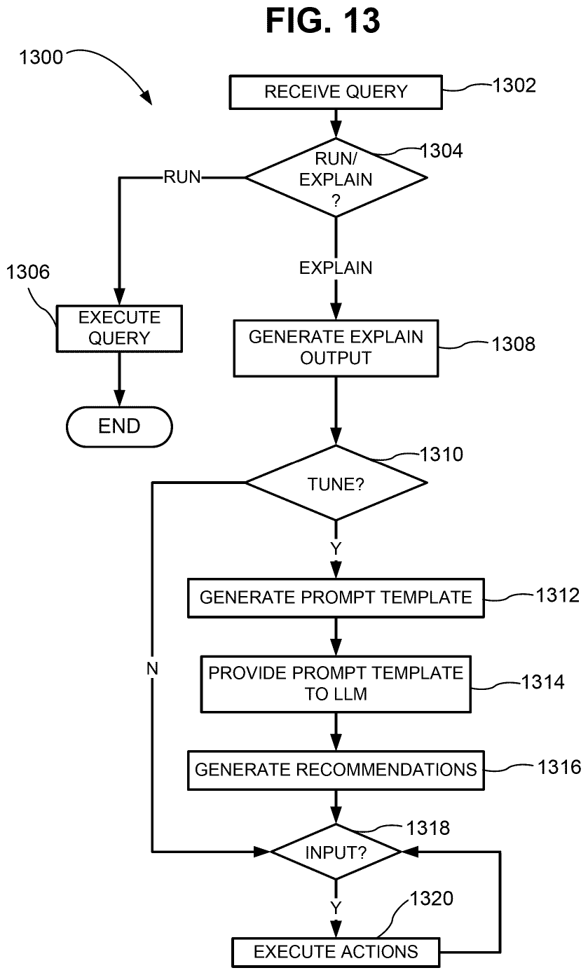

FIG. 13 is an operational flow diagram 1300 of the analytic platform 102 with the QE interface 800. In one example, a query, or other database task, may be received (1302). A decision to run or execute the query may be made (1304), if the decision is to execute, the query may be executed (1306). If the query is be explained via the EXPLAIN feature, the EXPLAIN output may be generated (1308). If a decision to tune the EXPLAIN output is made (1310), a prompt template, such as the prompt template 700, may be generated (1312). The prompt template may be provided to the fine-tuned LLM, such as the custom LLM 610 (1314). The recommended tuning actions may be provided based on the output of the fine-tuned LLM (1316). Once the recommended actions are generated, input determining use of the actions may be awaited (1318). If input is received, actions based on the input may be executed (1320).

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

I claim:

1. A system comprising:
a storage device configured to store a plurality of data:
a plurality of processing nodes in communication with the storage device, wherein at least one of the processing nodes is configured to:
receive a query on at least a portion of the data;
generate a query plan in natural language format;
generate a large language model (“LLM”) input based on the natural language format of the query plan;
execute an LLM on the LLM input;
generate, in response to execution of the LLM, a plurality of recommended actions to perform to improve the query plan;
receive input to execute at least one of the plurality of recommended actions; and
alter the query plan in accordance with the at least one of the plurality of recommended actions.

2. The system of claim 1, wherein the LLM input is a prompt template.

3. The system of claim 2, wherein the prompt template comprises output of an EXPLAIN statement on the query plan.

4. The system of claim 1, wherein the at least one processing nodes is further configured to:
receive input that comprises at least one inquiry on one or more of the recommended actions;
provide the input to the LLM; and
provide a response generated by the LLM.

5. The system of claim 1, wherein the LLM is trained on at least one of: benchmark data; workload information data; product information data; blog content data; support incident data; and forum discussion data.

6. The system of claim 1, wherein the query comprises a plurality of queries associated with a common workload.

7. A method comprising:
receiving, with a processor, a query on at least a portion of data stored in a storage device, wherein the storage device is in communication with the processor;
generating, with the processor, a query plan in natural language format;
generating, with the processor, a large language model (“LLM”) input based on the natural language format of the query plan;
executing, with the processor, an LLM on the LLM input;
generating, with the processor, in response to execution of the LLM, a plurality of recommended actions to perform to improve the query plan;
receiving, with the processor, input to execute at least one of the plurality of recommended actions; and
altering, with the processor, the query plan in accordance with the at least one of the plurality of recommended actions.

8. The method of claim 7, wherein the LLM input is a prompt template.

9. The method of claim 8, wherein the prompt template comprises output of an EXPLAIN statement on the query plan.

10. The method of claim 8, further comprising:
receiving, with the processor, input that comprises at least one inquiry on one or more of the recommended actions;
providing, with the processor, the input to the LLM; and
providing, with the processor, a response generated by the LLM.

11. The method of claim 7, wherein the LLM is trained on at least one of: benchmark data; workload information data; product information data; blog content data; support incident data; and forum discussion data.

12. The method of claim 7, wherein the query comprises a plurality of queries associated with a common workload.

13. A non-transitory computer-readable medium encoded with a plurality of instructions executable by a processor, the plurality of instructions comprising:
instructions to receive a query on at least a portion of data stored in a storage device;
instructions to generate a query plan in natural language format;
instructions to generate a large language model (“LLM”) input based on the natural language format of the query plan;
instructions to execute an LLM on the LLM input;
instructions to generate, in response to execution of the LLM, a plurality of recommended actions to perform to improve the query plan;
instructions to receive input to execute at least one of the plurality of recommended actions; and
instructions to alter the query plan in accordance with the at least one of the plurality of recommended actions.

14. The non-transitory computer-readable medium of claim 13, wherein the LLM input is a prompt template.

15. The non-transitory computer-readable medium of claim 14, wherein the prompt template comprises output of an EXPLAIN statement on the query plan.

16. The non-transitory computer-readable medium of claim 13, the plurality of instructions further comprising:
instructions to receive input that comprises at least one inquiry on one or more of the recommended actions;
instructions to provide the input to the LLM; and
instructions to provide a response generated by the LLM.

17. The non-transitory computer-readable medium of claim 13, wherein the LLM is trained on at least one of: benchmark data; workload information data; product information data; blog content data; support incident data; and forum discussion data.

18. The non-transitory computer-readable medium of claim 13, wherein the query comprises a plurality of queries associated with a common workload.
